(19) United States
(12) Patent Application Publication
(10) Pub. No.: US 2021/0241225 A1
(43) Pub. Date: Aug. 5, 2021

(54) SYSTEMS AND METHODS FOR ELECTRONIC INVENTORY AND RETURN ITEM RECONCILIATION

(71) Applicant: COUPANG CORP., Seoul (KR)

(72) Inventors: Erik REHN, Seoul (KR); Yul Hee LEE, Seoul (KR); Young Shin KANG, Seoul (KR)

(73) Assignee: COUPANG CORP

(21) Appl. No.: 16/781,518

(22) Filed: Feb. 4, 2020

(51) Int. Cl. G06Q 10/08; G06Q 10/06

(52) U.S. Cl. CPC G06Q 10/0833; G06Q 10/0633; G06Q 10/0832

(57) ABSTRACT

A computerized system for inventory item reconciliation process at a site, comprising: maintaining a database storing a plurality of records having package identifiers associated with packages; generating an interactive user interface at a first time, comprising a plurality of interactive elements depicting a status for each of the plurality of records in the database; prompting a display on the interactive user interface to perform reconciliation; receiving one or more scan events containing at least one or more package identifiers; determining mismatches of the package identifiers between the one or more scan events and the plurality of records; assigning an error status to the mismatches of the package identifiers; updating the plurality of record based on the mismatches of the package identifiers; and generating a status report on the interactive user interface for package identifiers having the error status.

### TECHNICAL FIELD

The present disclosure generally relates to computerized systems and methods for inventory management. In particular, embodiments of the present disclosure relate to inventive and unconventional systems and methods utilized for tracking items and maintaining an inventory database.

### BACKGROUND

Product delivery business heavily relies on computerized systems comprising various interconnected databases, interfaces and/or computer servers to manage a vast quantity of product items. Inventory management is particularly reliant on computer technology due to the fact that the quantities of items are so vast that individuals simply cannot manually manage all items in a warehouse, for example, as a mental exercise.

One example of an application of computer systems to inventory management is to track each item in an inventory. Each item in the inventory may correspond to an entry in one or more databases, with each entry having a plurality of fields. An interaction, such as scanning of a barcode or an RFID tag, may represent an update or change in one or more values in the plurality fields of the entry in the one or more databases. Thus, computer systems are integrally used in the method of inventory management. Moreover, information regarding items in the inventory may be utilized in various non-routine and unconventional manner to generate useful result in the form of “big data.” One important aspect is that the information contained in the various databases are accurate.

Prior inventory management systems and methods often lack an ability to resolve a status of certain items that are not processed by a predetermined standardized procedure, for example, when items that are misplaced. This may result in erroneous or outdated information being stored in the various databases regarding those items.

Therefore, there is a need for improved methods and systems for reconciliation of product items so that the integrity of the information stored in the various databases can be maintained.

### SUMMARY

One aspect of the present disclosure is directed to a computerized system for inventory item reconciliation process at a site, comprising: at least one processor; and at least one non transitory storage medium comprising instructions that, when executed by the at least one processor, cause the at least one processor to perform steps comprising: maintaining a database storing a plurality of records having package identifiers associated with packages; generating an interactive user interface at a predetermined time, comprising a plurality of interactive elements depicting a status for each of the plurality of records in the database; prompting a display on the interactive user interface to perform reconciliation; receiving one or more scan events containing at least one or more package identifiers; determining mismatches of the package identifiers between the one or more scan events and the plurality of records; assigning an error status to the mismatches of the package identifiers; updating the plurality of record based on the mismatches of the package identifiers; and generating a status report on the interactive user interface for package identifiers having the error status.

Another aspect of the present disclosure is directed to a method for inventory item reconciliation process at a site, comprising steps of: maintaining a database storing a plurality of records having package identifiers associated with packages; generating an interactive user interface at a predetermined time, comprising a plurality of interactive elements depicting a status for each of the plurality of records in the database; prompting a display on the interactive user interface to perform reconciliation; receiving one or more scan events containing at least one or more package identifiers; determining mismatches of the package identifiers between the one or more scan events and the plurality of records; assigning an error status to the mismatches of the package identifiers; updating the plurality of record based on the mismatches of the package identifiers; and generating a status report on the interactive user interface for package identifiers having the error status

Yet another aspect of the present disclosure is directed to a computerized system for inventory item reconciliation process at a site, comprising: at least one processor; and at least one non transitory storage medium comprising instructions that, when executed by the at least one processor, cause the at least one processor to perform steps comprising: maintaining a database storing a plurality of records having package identifiers associated with packages; generating an interactive user interface at a predetermined time, comprising a plurality of interactive elements depicting a status for each of the plurality of records in the database; prompting a display on the interactive user interface to perform reconciliation; receiving one or more scan events containing at least one or more package identifiers; determining mismatches of the package identifiers between the one or more scan events and the plurality of records; assigning an error status to the mismatches of the package identifiers; prompting a display on the interactive user interface to make further inquiries for the package identifiers having the error status; receiving an input via the interactive user interface regarding a current status of each of the package identifiers having the error status; updating the plurality of record based on the input; and generating a status report on the interactive user interface for package identifiers having the error status.

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Display Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3A depicts an exemplary embodiment of item distribution hierarchy, consistent with the disclosed embodiments.

FIG. 3B depicts an exemplary embodiment of inventory item reconciliation, consistent with the disclosed embodiments.

FIG. 3C depicts an exemplary embodiment of return item reconciliation, consistent with the disclosed embodiments.

FIG. 4 is a flow chart illustrating an exemplary embodiment of a method for maintaining a ledger for reconciliation, consistent with the disclosed embodiments.

FIG. 5 is a flow chart illustrating an exemplary embodiment of process for interacting with a computer system to update information stored in one or more databases based on reconciliation, consistent with the disclosed embodiments.

FIG. 6 depicts an exemplary embodiment of an interactive graphic user interface, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to computer-implemented systems and methods for maintaining computer systems and databases used to manage inventory. The disclosed embodiments provide innovative technical features that allow for efficient update and maintenance of entries in databases, by leveraging SKU based inventory management technology and mobile network infrastructure to ensure that entries in one or more databases are accurate and up-to-date. For example, the disclosed embodiments enable computer systems and databases to create a central ledger that can be regularly and automatically updated with the most current and accurate information. At the same time, the innovative uses of mobile network infrastructure and mobile devices provide accurate accounting of all items at different points of a delivery cycle, enabling computer systems and databases to generate reporting that is useful for reducing misplacement and theft.

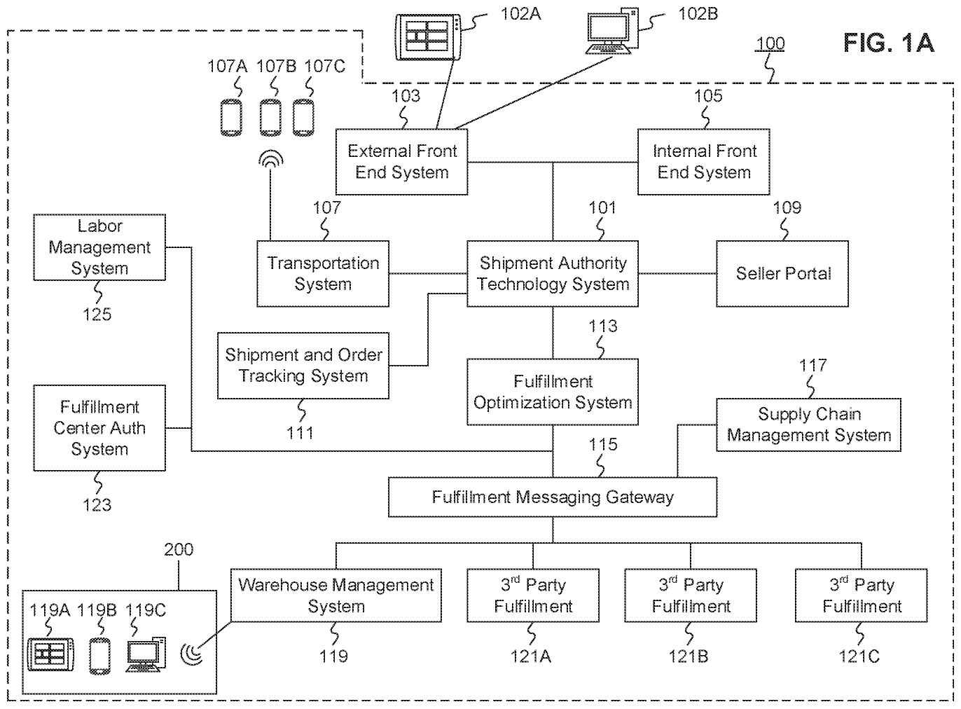

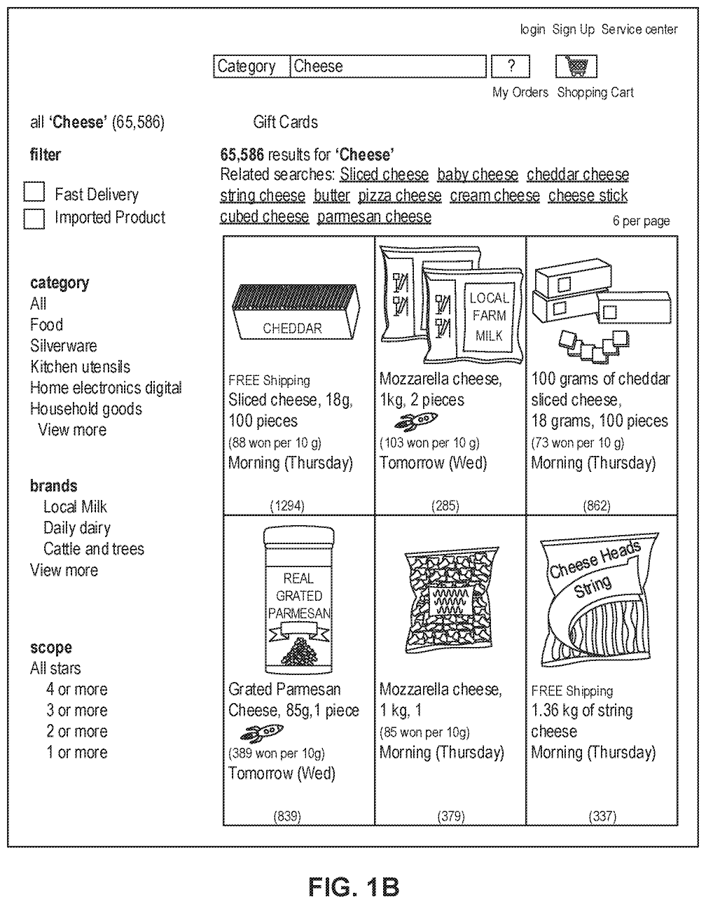

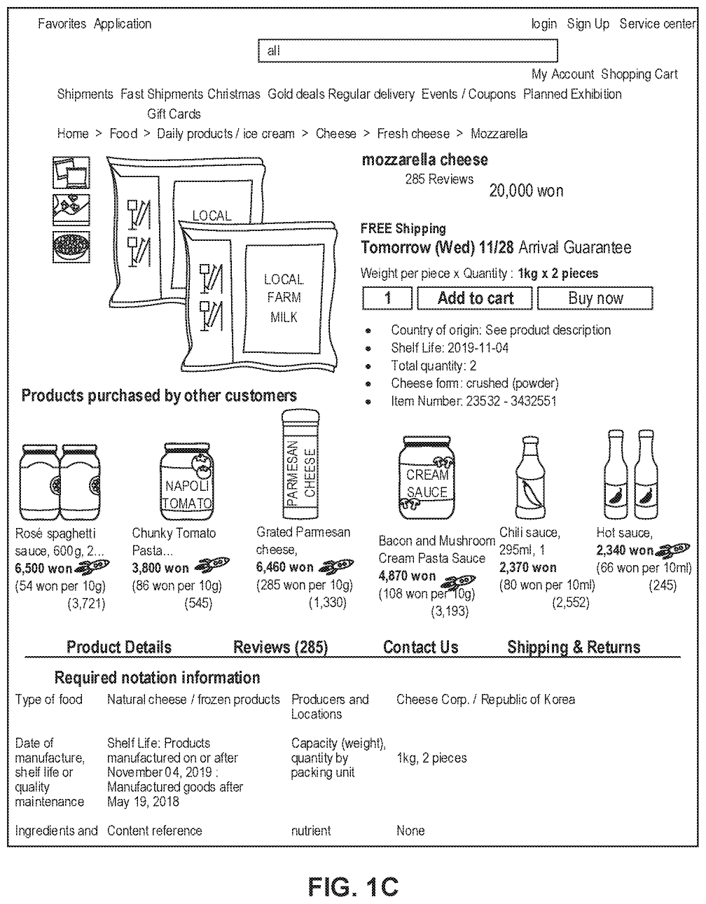

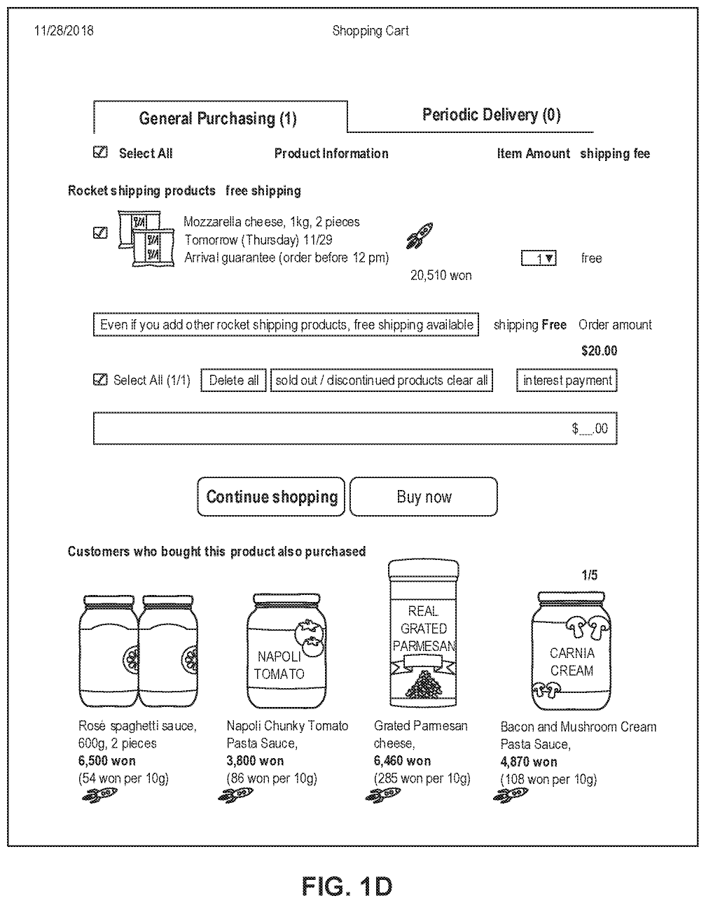

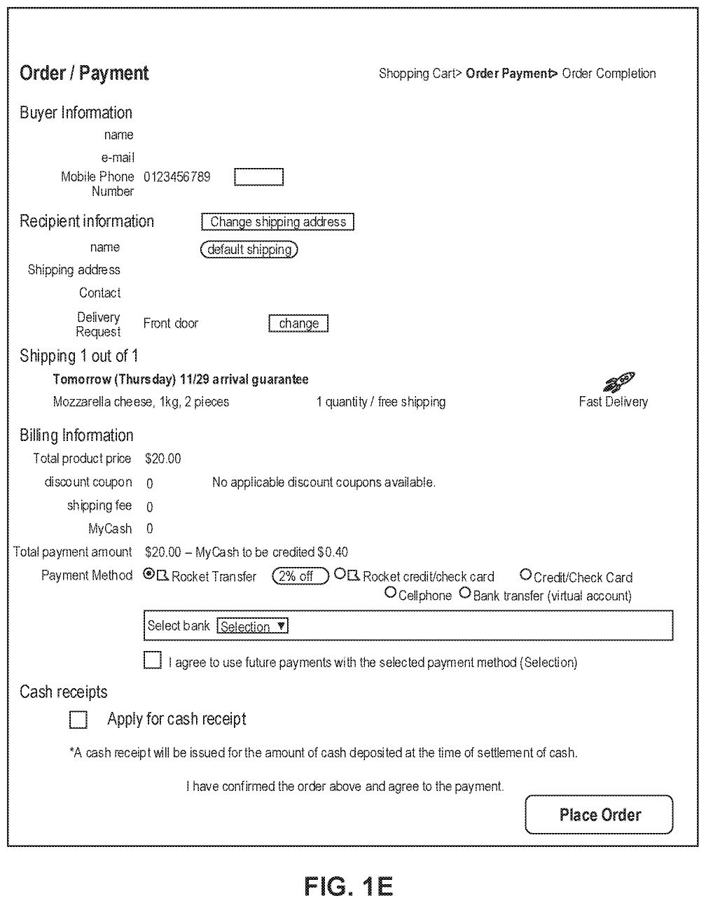

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 107B, and 107C, seller portal 109, shipment and order tracking (SOT) system 111, fulfillment optimization (FO) system 113, fulfillment messaging gateway (FMG) 115, supply chain management (SCM) system 117, warehouse management system 119, mobile devices 119A, 119B, and 119C (depicted as being inside of fulfillment center (FC) 200), 3^{rd} party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field, a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where network 101 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from warehouse management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfilment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3^{rd} party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

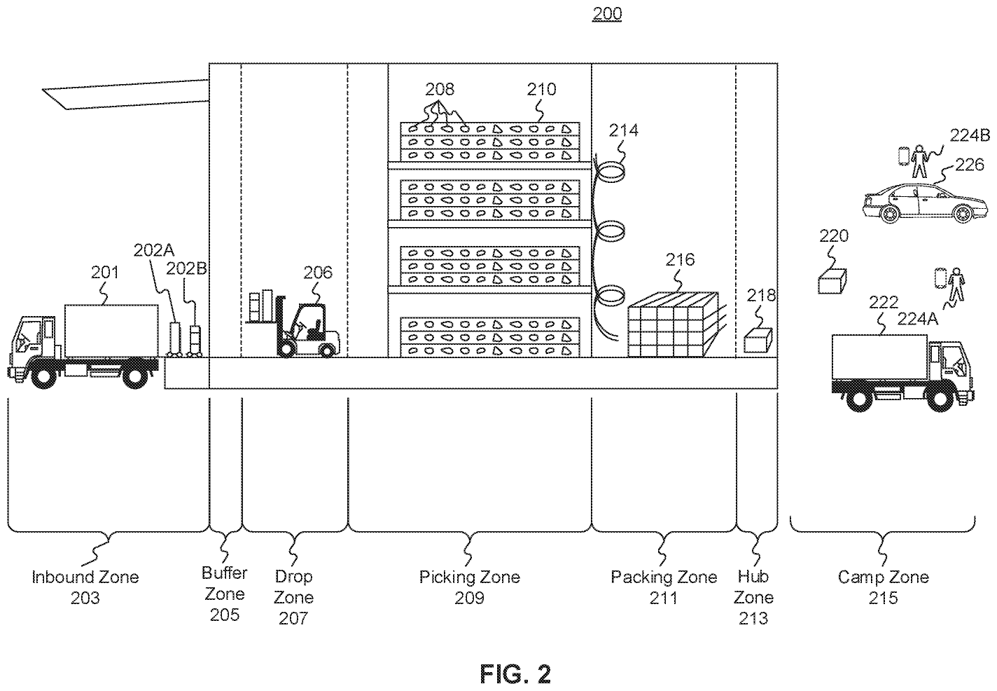

Warehouse management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 1198, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3^{rd} party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMA 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 2028. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 1198.

Once a user places an order, a picker may receive an instruction on device 1198 to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, a cart, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

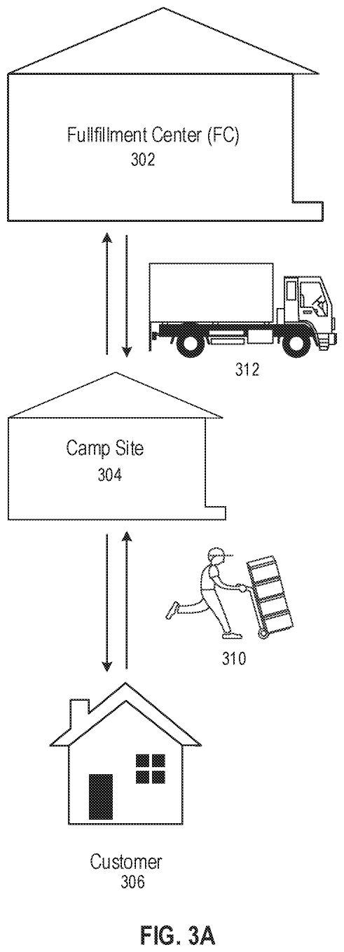

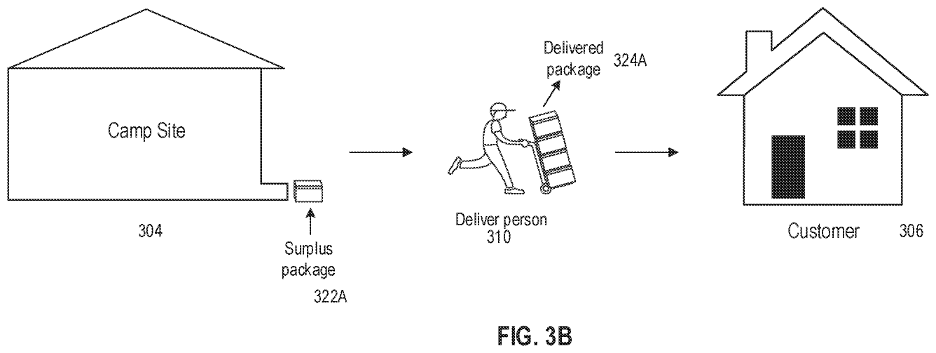

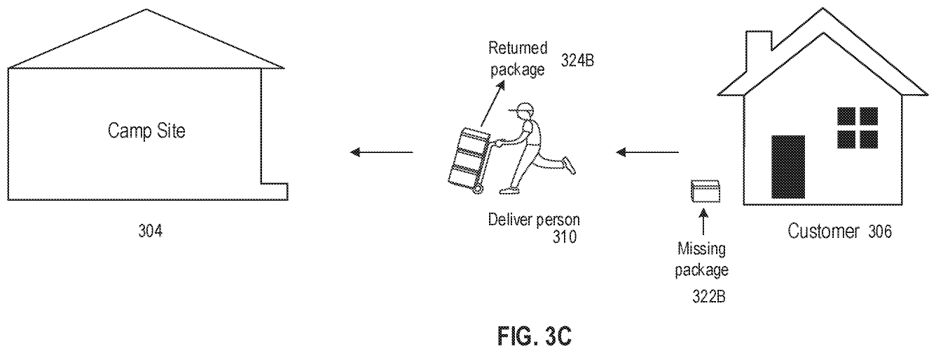

FIG. 3A, FIG. 3B, and FIG. 3C depict exemplary embodiments of need for item reconciliation. In some embodiments, FO system 113 performs various processes and tasks readying items for delivery based on orders placed. In some embodiments, items may originate from Fulfillment Center (FC) 302, which may represent FC 200. In some embodiments, delivery vehicle 310 may transport the items from FC 302 to camp site 304. In some embodiment, camp site 304 may be a distribution site, to where a large quantity items for many orders are transported. In some embodiment, camp site 304 are more numerous in number than FC 302. In some embodiment, camp site 304 may be geographically located closer to customer 306 than FC 302.

In some embodiments, delivery person 310 delivers items from camp site 304 to customer 306. Delivery person 310 may be a flex worker 224B, or a full-time worker 224A, who may possess one or more of mobile devices 107A-10C. In some other embodiments, delivery person 310 returns items from customer 306 to camp site 304. Camp site 304 may correspond to camp zone 215. In some embodiments, camp site 304 may contain inventory/return items, which include surplus package 322A and packages 324A/B (in FIGS. 3B and 3C). Information regarding the inventory items may be stored in form of a data structure, such as entries containing a plurality of fields corresponding to values associated with the item. In some embodiments, the entries are associated with unique identifiers, which may be assigned barcodes or RFID tags. The information regarding the inventory items may be stored on and accessed from one or more databases connected to system 100 illustrated in FIG. 1A. For example, WMS 119, FO system 113 or transportation system 107 may access and modify the information regarding the inventory items, including the entries and fields associated with a particular item. In some embodiments, mobile devices such as 107A-107C connected to system 100 may also access and modify the information regarding the inventory items, including the entries and fields associated with the particular item.

FIG. 3B illustrates an exemplary delivery. Transportation system 107, based on orders placed through system 100, assigns inventory items, i.e. items stocked from camp site 304 for delivery. In some embodiments, delivery person 310 receives an instruction from transportation system 107 to update entries in the one or more databases to indicate that items are out on delivery. For example, delivery person 310 may scan every item that is to be delivered prior to beginning the delivery using mobile device 107A-107C. It may be the case that due to oversight or other circumstances, delivery person 310 fails to scan every item to be delivered. Additionally, or alternatively, it may be the case that delivery person 310 fails to take possession of all items that he/she scanned. Additionally, or alternatively, it may be the case that delivery person 310 fails complete the delivery due to various difficulties, and returns the undelivered items to camp site 304. Additionally, or alternatively, it may be the case items for delivery may be canceled, and no delivery will take place. In these cases, or other similar cases, such items may become surplus package 322A, while items that are processed normally are verified and become delivered package 324A. Thus, the information of surplus package 322A contained in its database entry may not reflect on its true status, therefore causing errors in the one or more databases and comprising the accuracy and integrity of information stored in the databases.

FIG. 3B illustrates an exemplary item return. In some embodiments, an item must be returned to camp site 304 due to various reasons, such as rejection by customer 306. Delivery person 310 arrives at customer 306 to pick up the return item, and receives an instruction from transportation system 107 to updates entries in the one or more databases to indicate that items are picked up for return. For example, delivery person 310 may scan every item that is to be returned prior to beginning the returning with the items. It may be the case that due to oversight or other circumstances, delivery person 310 may not have scanned every item to be returned. Additionally, or alternatively, it may be the case that delivery person 310 fails to take possession of all items that he/she scanned. In these cases, or other similar cases, such items may become missing packages 322B, while items that are processed normally are verified become returned packages 324B. Thus, the information of missing packages 322B contained in its database entry may not reflect on its true status, therefore causing errors in the one or more databases, hence compromising the accuracy and integrity of information stored in the databases.

A person of ordinary skill in the art will appreciate that, in some embodiments, delivery person 310 may have additional or alternative methods of updating package status. In some embodiments, mobile devices 107A-107C may be configured to receive inputs from delivery person 310 other than scanning. In some embodiments, mobile devices 107A-107C may generate graphical user interfaces that provide for interaction by delivery person 310. For example, mobile devices 107A-107C may generate graphical elements representing items, and delivery person 310 may update status of items by “pressing” the corresponding graphic elements on mobile devices 107A-107C. Such graphical elements may be, for example, a drop-down list, check boxes or graphic icons.

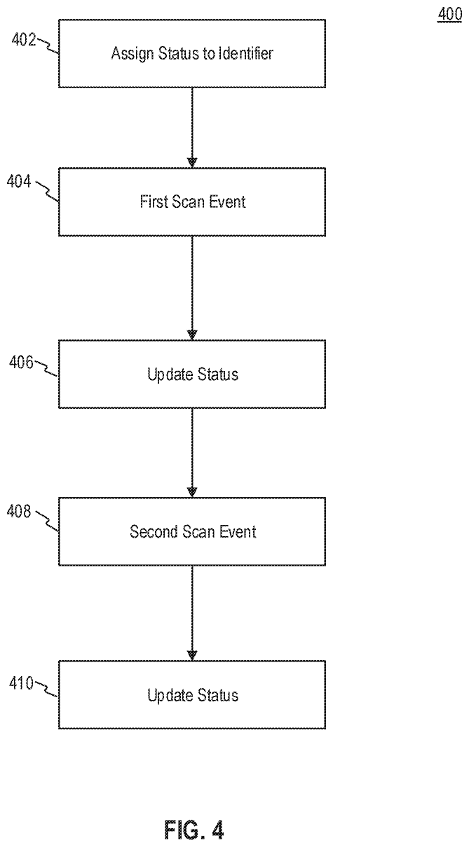

In some embodiments, at end of a delivery shift, such as the end of business day, personnel at camp site 304 may perform reconciliation of all items that remain at camp site 304. These remaining items may be a combination of surplus package 322A and returned package 324B. The reconciliation process attempts to check all remaining items with a ledger of items. In some embodiments, the ledger may be created or maintained by transportation system 107 and their associated databases. The ledger may be, for example, a list of entries of identifiers that arrive and leave a particular camp site 304 over a predetermined time period. The ledger may be implemented in some embodiments as a database, a data store, a data structure, a data file, or any other arrangement of data (including, e.g., a flat data file or a Comma-Separated Value file). The process of creating and updating the ledger is described below with reference to FIG. 4.

FIG. 4 is a flow chart illustrating an exemplary embodiment of a method for maintaining a ledger for reconciliation.

In step 402, FO system 113, WMS 119, or transportation system 107 may assign a status to an identifier and place the identifier in the ledger. The identifier is associated with an item, and is represented in the ledger as an entry. The entry representing the identifier may contain a plurality of fields, one of which may correspond to the status. The status may be, for example, an indication of which step of delivery process is item currently at. The status, among other things, may indicate that the item is waiting to be picked up by delivery person 310, being transported by delivery person 310, or arrived at destination. In some embodiments, the status may also indicate that the item is an inventory item (a stocked item waiting to be delivered) or a return item (item to be returned to camp site 304). In some embodiments, FO system 113, WMS 119, or transportation system 107 assigns the identifier an initial status, which indicates that the item is ready for pick-up. In some embodiments, FO system 113, WMS 119, or transportation system 107 assigns the identifier a time frame, such as Promised Delivery Date (PDD). The time frame may indicate an amount of time that may lapse before an action must be taken. In some embodiment, FO system 113, WMS 119, or transportation system 107 may receive information about the items in the one or more databases connected to system 100. The information may be received from an order placed, or a return request. In some embodiments, FO system 113 or WMS 119 may assign the status in step 402 when items are located in FC 302. In some embodiments, transportation system 107 may assign the status in step 402 for items that are no longer located in FC 302.

In step 404, transportation system 107 may register an interaction with the identifier. In some embodiments, the identifier is assigned a barcode or a QR code, and the interaction may be a scan by mobile devices 107A-107C by delivery person 310. An ordinary skilled person will now appreciate that other methods or systems of machine interaction, such as RFID or manual interaction with an GUI, may be implemented as alternatively embodiments.

In step 406, when transportation system 107 registers an interaction in step 404, transportation system 107 updates the status associated with the identifier corresponding to the item. For example, when delivery person 310 scans the barcode, transportation system 107 may determine that delivery person 310 has taken possession of the item in question. In some embodiments, transportation system 107 modifies the entry in the ledger corresponding to the item to indicate that the status of the item may be different than the initial status.

In step 408, transportation system 107 may register another interaction with the identifier. In some embodiments, the interaction may be a scan by mobile devices 107A-107C by delivery person 310, similar to step 404.

In step 410, transportation system 107 may determine a final status associated with the identifier corresponding to the item. In some embodiment, transportation system 107 may change the entry in the one or more databases corresponding to the item to indicate that item has been either been successfully delivered, returned from customer 306, or returned from a failed delivery.

In some embodiment, as illustrated in FIG. 3B, it may be the case that delivery person 310 has failed to locate the item or otherwise failed to take the item into possession from camp site 304. Such items may become surplus package 322A, mixed in with items that are canceled or items that are returned from customer 306. Similarly, in some embodiment, as illustrated in FIG. 3C, it may be the case that delivery person 310 has failed to locate the item or otherwise failed to take the item into possession from customer 306. Such items may be come missing package 322B. Because it may be difficult to distinguish the different status of items that remain at camp site 304 at the end of business, a reconciliation process is required. In some embodiments, the remaining items may be reconciled at a time interval, such as at an end of a delivery shift, which may be different from the end of business. In some other embodiments, integrity of information stored in the ledger is checked at this shortened time interval.

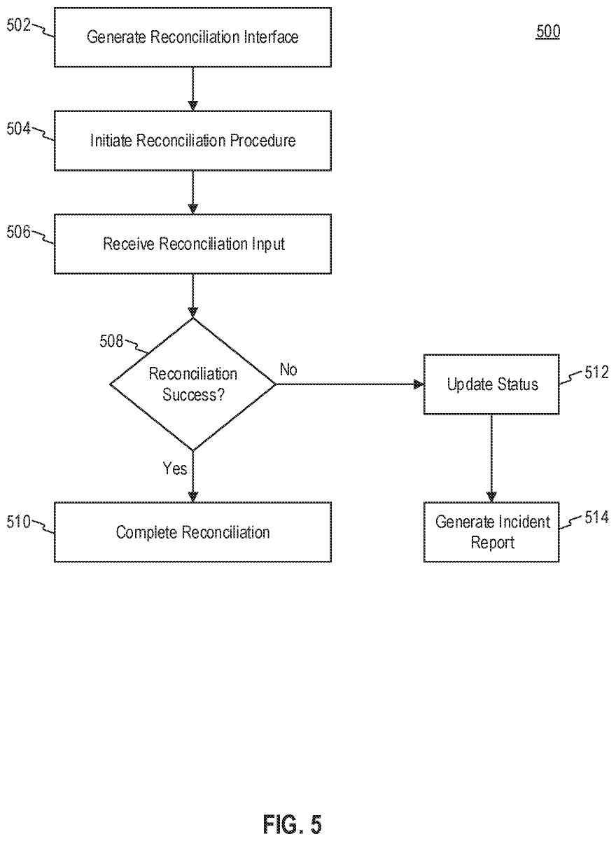

FIG. 5 is a flow chart illustrating an exemplary embodiment of process for interacting with a computer system to update information stored in one or more databases based on a reconciliation process.

In step 502, transportation system 107 generate an interactive user interface for reconciliation. In some embodiments, the interface may be generated at predetermined time, such as end of delivery shift or end of business day. In some embodiments, the interactive user interface may be generated by a trigger by the one or more databases connected to system 100, or be triggered by other subsystem of system 100. In some embodiment, transportation system 107 may generate the interactive user interface for reconciliation at the end of every month, week, hour, or close of business every day.

In step 504, transportation system 107 may prompt the interactive user interface to display various information relating to the reconciliation, including reconciliation procedures. The interactive user interface may be displayed on various mobile or computer devices 107A-107C. In some embodiments, the interactive user interface may display a set of instructions to personnel at camp site 304 to scan all remaining items at camp 304. The interactive user interface may provide relevant statistics to a user. In some embodiments, the interactive user interface may contain elements that may be used to provide inputs to transportation system 107.

In some embodiments, as part of the reconciliation procedure, transportation system 107 accesses the ledger created in process 400 to create a reconciliation list. The reconciliation list contains entries from the ledger that transportation system 107 predict to be present among the remaining items. In some embodiments, the interactive user interface may display the information contained in the ledger or the reconciliation list.

In step 506, transportation system 107 receives reconciliation input from personnel authorized to reconcile items using the interactive user interface. For example, a manager at camp site 304 may be tasked with reconciliation of the surplus packages 324A. In some embodiment, the reconciliation input may be an indication as to whether an item is found. In some embodiment, the input may be provided as scan events similar to step 404 or step 408 in process 400, where the personnel scans the items present, and transportation system 107 registers the scan events as the indication that the items present. Alternatively, the personnel may manually reconcile the items by inputting that the item is present.

In step 508, transportation system 107 may determine, based on the input received via the interactive user interface, whether reconciliation is successful. For example, if the personnel at camp 304 indicates that a particular item is found, and that item is listed on the reconciling list, then that item is found, and “Reconciliation Success” is “Yes” for that item. Alternatively, if the personnel at 304 indicates that an item is found, but the item is not listed on the reconciliation list, then “Reconciliation Success” is “No” for that item. In some embodiments, once the personnel have completed inputs for all items remaining at camp site 304, the personnel may provide an indication that all items has been checked to transportation system 107 via the interactive user interface. If the reconciling list still contain items that were not inputted, those items cannot be located or found, then transportation system 107 will set “Reconciliation Success” is “No” for items that are not found.

In step 510, if reconciliation is successful, transportation system 107 assigns status to item's identifier an appropriate status. For example, if surplus package 322A is found during reconciliation, transportation system 107 may update the entry associated with surplus package 322A so that its status is reset to a default status assigned prior step 402.

If “Reconciliation Success” is “No” in step 508, transportation system 107 may require further inputs from the personnel regarding that item in step 512. The personnel may be prompted via the interactive user interface to ascertain further information regarding that item. For example, if that item in question is not found, the personnel may make further inquiries to warehouse workers to ascertain whether that item has been packed, the personnel may make further inquires to delivery person 310 or customer 306 to ascertain the location of that item. Similarly, for surplus package 322A that is not on the reconciling list, the manager may make further inquiries to delivery person 310 or customer 306 to ascertain why surplus package 322A is undelivered.

In step 512, the manager may provide input to transportation system 107 via the interactive interface relevant information gathered regarding of items that failed reconciliation. transportation system 107 receives this information, and updates the entry corresponding to the items to indicate a final disposition. The final disposition may be, for example, that a lost item is eventually found, irrevocably lost, or that delivery is rearranged for undelivered items. In some embodiments, transportation system 107 may update the entry with additional information, to indicate the origin of the item, the destination of the item, the delivery person that handled the item, and/or type of loss. Type of loss may be a category, to which reasons for losing the reconciling item may be attributed.

In step 514, transportation system 107 may generate incident report. Incident report may contain information obtained in step 512, such as the origin of the item, the destination of the item, the delivery person that handled the item, and/or type of loss.

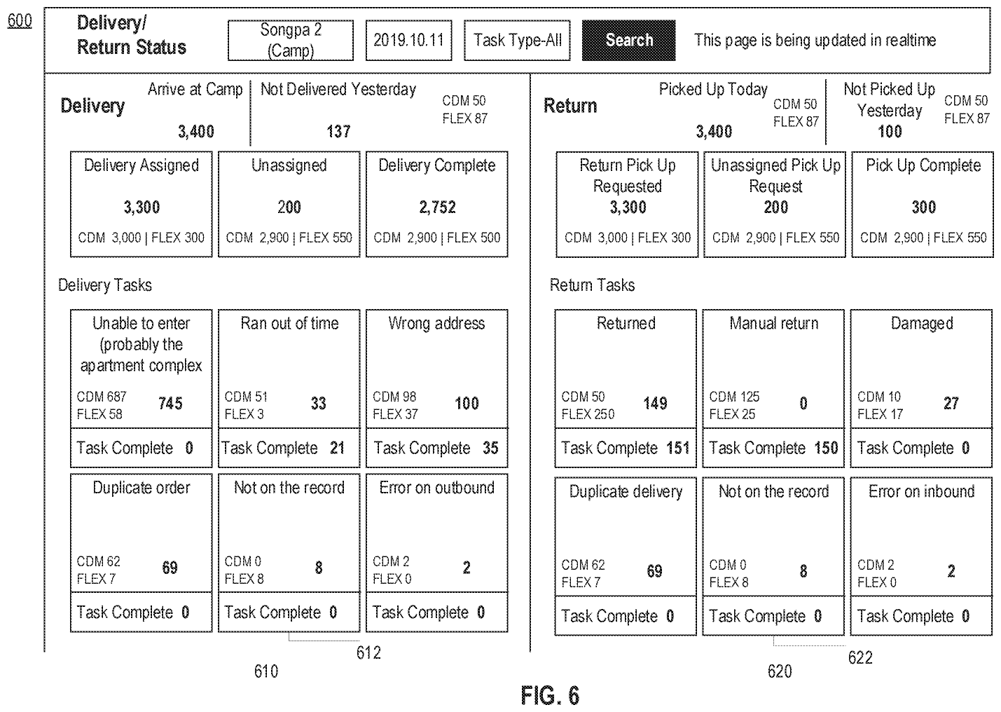

FIG. 6 depicts an exemplary embodiment of an interactive graphic user interface (GUI) 600. In some embodiment, transportation system 107 may generate GUI 600 during the reconciliation process at the set time prior to end of business. Alternatively, GUI 600 may be generated for display through-out the business hours, containing information in addition to the reconciliation. In some embodiments, GUI 600 may be displayed on devices 107A-107C.

In some embodiments, GUI 600 may contain various interactive elements, which may allow a user to access different functions. In some embodiment, GUI 600 divides the various interactive elements into regions, 610 and 620. Region 610 contain interactive elements that governs items related to delivery, such as 322A and 324A shown in FIG. 3B, while region 620 contains interactive elements that governs items related to return, such as 322B and 324B shown in FIG. 3C. In some embodiments, the numbers contained in the elements may be obtained from the ledger or the reconciliation list.

Elements in Region 610 corresponds to an interactive element that categorizes the different situations that contributes surplus packages 322A. In some embodiment, a user may select element 612, and transportation system 107 will generate additional elements that solicit further input from the user to complete the reconciliation process, such as a final disposition of the items in that category. In some embodiment, element 612 may also display statistics relating to the reconciliation process. For example, element 612 may display a total number of items of reconciliation process that awaits completion, a total number reconciliation process that has been completed, and whether a total of reconciliation process that is related to CDMs Flex workers respectively.

Elements in Region 612 corresponds to an interactive element that categorizes the different situations that contributes surplus packages 322A from items that were returned. In some embodiment, a user may select element 612, and transportation system 107 will generate additional elements that solicit further input from the user to complete the reconciliation process, such as a final disposition of the items in that category. In some embodiment, element 622 may also display statistics relating to the reconciliation process. For example, element 622 may display a total number of reconciliation process that awaits completion, a total number reconciliation process that has been completed, and whether a total of reconciliation process that is related to CDMs Flex workers respectively.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A computerized system for inventory item reconciliation process at a site, comprising:
at least one processor; and
at least one non-transitory storage medium comprising instructions that, when executed by the at least one processor, cause the at least one processor to perform steps comprising:
maintaining a database storing a plurality of records having package identifiers associated with packages;
generating an interactive user interface at a first time, comprising a plurality of interactive elements depicting a status for each of the plurality of records in the database;
prompting a display on the interactive user interface to perform reconciliation;
receiving one or more scan events containing at least one or more package identifiers;
determining mismatches between the at least one or more package identifiers of the one or more scan events and the package identifiers of the plurality of records;
assigning an error status to the mismatches of the package identifiers;
updating the plurality of record based on the mismatches of the package identifiers;
receiving an input via the interactive user interface regarding a current status of each of the package identifiers having the error status; and
generating the final status of each of the plurality of records based on the input.

2. (canceled)

3. The system of claim 1, wherein the first time is midnight of a working day.

4. The system of claim 1, wherein the first time corresponds to an end of a delivery shift.

5. The system of claim 1, wherein receiving the one or more scan events comprise forwarding instructions to at least one mobile device associated with the site, the instructions configured to display instructions to scan package identifiers associated with packages present at the first time at the site.

6. The system of claim 5, the steps further comprising:
receiving an indication that all of the package identifiers associated with packages present at the first time at the site have been scanned; and
determining mismatches of the package identifiers that are present in the plurality of records and missing from the site.

7. The system of claim 1, wherein receiving one or more scan events further comprises receiving a scan event from a remote device.

8. The system of claim 1, wherein the plurality of records comprises a plurality of first records having package identifiers associated with packages for delivery.

9. The system of claim 1, wherein the plurality or records comprises a plurality of second records having package identifiers associated with the packages for return.

10. A method for computerized inventory and return item reconciliation, comprising steps of:
maintaining a database storing a plurality of records having package identifiers associated with packages;
generating an interactive user interface at a first time, comprising a plurality of interactive elements depicting a status for each of the plurality of records in the database;
prompting a display on the interactive user interface to perform reconciliation;
receiving one or more scan events containing at least one or more package identifiers;
determining mismatches between the at least one or more package identifiers of the one or more scan events and the package identifiers of the plurality of records;
assigning an error status to the mismatches of the package identifiers;
updating the plurality of record based on the mismatches of the package identifiers;
receiving an input via the interactive user interface regarding a current status of each of the package identifiers having the error status; and
generating the final status of each of the plurality of records based on the input.

11. (canceled)

12. The method of claim 10, wherein the first time is midnight of a working day.

13. The method of claim 10, wherein the first time corresponds to an end of a delivery shift.

14. The method of claim 10, wherein receiving the one or more scan events comprise forwarding instructions to at least one mobile device associated with the site, the instructions configured to display instructions to scan package identifiers associated with packages present at the first time at the site.

15. The method of claim 14, the steps further comprising:
receiving an indication that all of the package identifiers associated with packages present at the first time at the site have been scanned; and
determining mismatches of the package identifiers that are present in the plurality of records and missing from the site.

16. The method of claim 10, wherein receiving one or more scan events further comprises receiving a scan event from a remote device.

17. The method of claim 10, wherein the plurality of records comprises a plurality of first records having package identifiers associated with packages for delivery.

18. The method of claim 10, wherein the plurality or records comprises a plurality of second records having package identifiers associated with the packages for return.

19. A computerized system for computerized inventory and return item reconciliation, comprising:
at least one processor; and
at least one non-transitory storage medium comprising instructions that, when executed by the at least one processor, cause the at least one processor to perform steps comprising:
maintaining a database storing a plurality of records having package identifiers associated with packages;
generating an interactive user interface at a first time, comprising a plurality of interactive elements depicting a status for each of the plurality of records in the database;
prompting a display on the interactive user interface to perform reconciliation;
receiving one or more scan events containing at least one or more package identifiers;
determining mismatches between the at least one or more package identifiers of the one or more scan events and the package identifiers of the plurality of records;
assigning an error status to the mismatches of the package identifiers;
prompting a display on the interactive user interface to make further inquiries for the package identifiers having the error status;
receiving an input via the interactive user interface regarding a current status of each of the package identifiers having the error status;
updating the plurality of record based on the input; and
generating a status report on the interactive user interface for package identifiers having the error status.
